(19) United States
(12) Patent Application Publication
(10) Pub. No.: US 2008/0187122 A1
(43) Pub. Date: Aug. 7, 2008

(54) Telephone Number Allocation

(76) Inventor: Colin Lawrence Melvin Baker, Auckland (NZ)

Correspondence Address: BROOKS KUSHMAN P.C., 1000 TOWN CENTER, TWENTY-SECOND FLOOR, SOUTHFIELD, MI, 48075, US

(21) Appl. No.: 11/813,633

(22) PCT Filed: Jan. 17, 2006
(86) PCT No.: PCT/NZ06/00001

§ 371 Date: Jul. 10, 2007

(30) Foreign Application Priority Data
Jan. 20, 2005 (NZ) 537800

(51) Int. Cl. H04M 3/42

(52) U.S. Cl. 379/218.01

(57) ABSTRACT

To provide a globally useful telephone number a character string which may be similar to an email address may be provided to a mobile phone server or an internet server for translation to the actual phone number and establishment of a call to that number.

### TECHNICAL FIELD

The invention generally relates to the allocation of telephone numbers and to telephone number portability.

More particularly the invention relates to the allocation of telephone numbers so that a telephone subscriber has a phone number usable globally.

### BACKGROUND ART

It is known that a telephone number which is usable globally is highly desirable.

While there are numbering schemes which allow calling a phone in any country there is no method of allocating a telephone number to a person or a mobile telephone which will allow the telephone to be rung from any location in the world. Similarly, in most countries, it is not possible to transfer among phone providers and retain the same telephone number.

The closest approach requires the use of a telephone linked directly to a satellite, as for instance the Iridium® multiple satellite system which can provide communications from anywhere in the world by linking to one of a constellation of orbiting satellites.

A second method relies on the use of a cell phone which is inter-operable with the majority of cell phone systems available, and which can be entered into the database of a telephone service provider in a country concerned prior to the phone being brought into the country by a person. Some organisation beforehand is required.

It is possible to have the cell phone system in a country recognize the entry of a previously unrecognised phone as it connects to a local cell, recognise the cell phone origin, and interrogate the country of origin for the details it requires to work with the phone, but such systems require co-operation between providers in different countries and the infrastructure in many countries currently prevents this.

Other systems have proposed to treat a phone as a network card is treated in the Internet, that is, the phone has a unique network ID which can be detected from anywhere in the world, and the signal for the phone transmitted to the phone either via the internet or via routing against a route extracted from the internet. Again considerable co-operation between providers is required for such a system to gain wide coverage.

There are already systems in existence which define the format of a global telephone number, such as standard E.164, and draft standards which define ways in which this number can be presented as an internet translatable URI (Universal Resource Identifier—see RFC3986). For instance a global number may translate under ENUM (E.164 to Uniform Resource Identifiers Dynamic Delegation Discovery System Application) as the domain name “tel: 3.8.0.0.6.9.2.3.6.1.4.4.e164.arpa” or under the Internet Society RFC2086 as “tel: +380069236144” or “tel: 36144;phone-context=watt.co.nz”. None of these methods produces a name which is particularly memorable.

The general public has become used to seeing URI's presented without the initial scheme identifier (such as “http:”), and the use of the identifiers which are peculiar to telephony, such as “tel:”, “sip:” is virtually unknown.

Mobile telephones now have alphanumeric keyboards, and displays to view entered data. While entry of numbers is comparatively quick entry of names is slower, but technology is allowing faster entry as time passes. Certainly it is easier to remember a name than to remember a string of numbers. Hence it is desirable to enter a name rather than a telephone number, however telephone exchanges do not accept names.

Other systems of relating such alphanumeric strings to telephone numbers in a network environment are known, such as US patent application publication U.S. 2003/0074461, but these solutions require passing identifiers for the type of query presented, which implies some type of user knowledge of what to do. This is generally not available.

The present invention provides a solution to this and other problems which offers advantages over the prior art or which will at least provide the public with a useful choice.

### SUMMARY OF THE INVENTION

In one exemplification the invention consists in a method of looking up a phone address as a URI comprising allocating a URI as the phone address, the URI being located within an existing authority domain, on interrogation of the domain recognising that the URI does not relate to a valid page, subsequently comparing the URI with a list of phone number aliases, and returning the phone number to which the alias relates to the interrogating process.

Preferably the URI is a URL and the phone number alias is formatted as a userinfo subcomponent in an authority domain name.

Preferably the URL includes a delimiter replacing the standard userinfo delimiter.

Preferably the URI is a URL and the phone number alias is formatted as a subcomponent of the authority domain name with an identifiable first subcomponent.

Preferably the first subcomponent is “gpn”.

In an alternative embodiment the invention relates to a method of providing an alias to a telephone number comprising specifying a phone number alias as a validly formatted hypertext transfer protocol (HTTP) address, detecting on query at the server corresponding to the address that the address does not relate to a valid HTTP page, confirming that the address relates to a phone number alias, and returning to the querying process the phone number and location relating to the alias.

Preferably the location identifies the phone code for a country.

Preferably the phone number and location are returned in standard international phone number format.

In a yet further embodiment the invention consists in apparatus for translating a telephone number being syntactically a valid domain name, the apparatus having:
a recogniser at the server representing the domain name which detects the syntactically valid domain name as a non-existent domain name reference and attempts to match the syntactically valid domain name against an entry in a list of phone number aliases
wherein on detecting a match the recogniser returns the phone number of which the syntactically valid domain name is the alias.

A further embodiment of the invention relates to an apparatus for translating a telephone number alias presented as a userinfo prefix, an authority domain name suffix and a valid URI separator between the two, the apparatus having:
a domain name recogniser
a recogniser for the separator which recognises it as denoting the prefix as being a phone number alias
a phone number alias lookup which returns the phone number equivalent to the userinfo prefix.

Preferably the apparatus is incorporated in a web server.

These and other features of as well as advantages which characterise the present invention will be apparent upon reading of the following detailed description and review of the associated drawings.

### BRIEF DESCRIPTION OF THE DRAWINGS

FIG. 1 is a first block diagram of a first implementation of the invention

FIG. 2 is a block diagram of the detection of a phone address in a web server.

FIG. 3 shows the process as it takes place at the calling phone.

### DESCRIPTION OF THE INVENTION

It is proposed to use as a phone number a name similar to that of an email. The separating “@” used in an email may be replaced by a different character which is similarly reserved in a URI. Such a character could be one of the existing characters already reserved for use in the URI, such as a “.” or “$”. This has the advantage that a telephone user may have a phone number and an email name which are almost identical. Thus an email might be mailto:joel.bloggs@trisotto.com.au while the phone name could be http://joel.bloggs.trisotto.com.au or http://joel.bloggs$trisotto.com.au. The telephone authority name may have a distinctive leader to enable easy identification of the fact that this is a telephone name, for instance a leader such as “gpn” will give a phone name of http://gpn.joel.bloggs.trisotto.com.au indicating to the server at trissotto.com.au that this is a global phone number. As yet another alternative the use of phone names may be restricted to a single authority domain which specialises in translating phone names to phone numbers and directing a call to the actual phone called. In such a system a phone name might be http://joel.bloogs.trisotto.com.au@gpn.com, this being a standard format for a userinfo subcomponent (see RFC 3986) and an authority domain name. As a variation, a complete domain could be named as .gpn and dedicated to the redirection of calls to phones so that joel.bloggs@trissotto.com.au.gpn would be a viable domain name.

Each of these possible methods of naming requires a different method of handling the phone call which issues to these addresses.

It is assumed that a phone will always have an allocated number, which may be global or local, but may be called by use of the alias as used above.

It is assumed that a phone can always call outwards, since it has only to identify a cellphone server or exchange which it can interrogate. Calling in to a phone using an alias is the problem which the current invention solves.

FIG. 1 shows a call from one phone (101) to another (108) using an alias, as for instance joel.bloggs.trisotto.com.au. Phone (101) is connected to cellphone server (102), although a POTS exchange server may be substituted where the calling telephone is not a cellphone, provided that the exchange is equipped to handle the input of alphanumeric codes (as for instance in text dialling). The cellphone server is connected to a digital network having internet and telephone gateway access. The cellphone server (102) receives a request for a call from phone (101), the called phone being identified only by an authority domain name string. No scheme identifier is used, but the server/exchange (102) to which the calling phone is connected is set to assume that the call is an http scheme call since a) there is no scheme shown, and b) the called name is neither numeric nor meets the requirements for an IP address. The server therefore hands off the call to a DNS (Domain Name Server) (103) which will attempt to find the domain name (trisotto.com.au). Assuming it succeeds in this it passes back the IP address to the server which initially interrogated it. The cellphone server then interrogates the address corresponding to http://joel.bloggs.trisotto.com.au which is on host server (104).

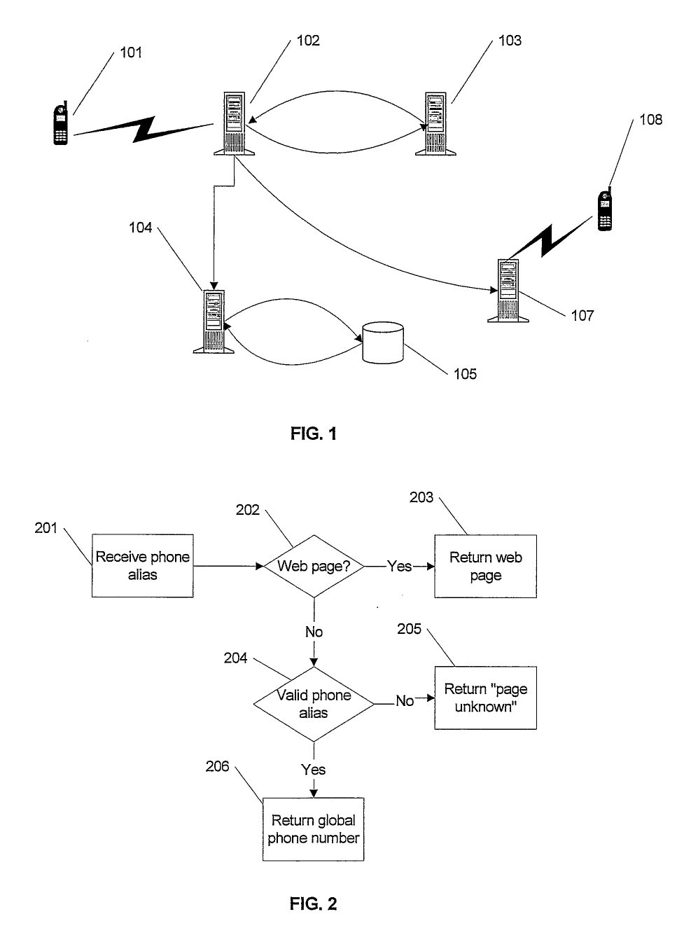

The host server responds by recognising that the page requested is actually a phone number request and providing the current location of the called phone. As shown at FIG. 2 it gets this by receiving the phone alias as a URL at (201) and returning a web page if this is a valid web page address at (203). If the page is not a valid page the error routine compares the address by string comparison against a list of phone number aliases held in the server at (204) in a known manner and if this is a recorded phone number alias at returns it at (206). If it is not a valid phone address the standard error page is returned. The returned number may be either the local number and country identifier or it may be a number in one of the standard global formats such as ENUM.

The format of the returned message may be any valid format which is recognised by the calling server as a phone number, for instance it may merely be the HTTP response with a pre-defined header carrying the phone number, or it may be a full HTTP SOAP message including the phone number, or it may be an HTML page including the phone number in a known format. The cellphone server retrieves the phone number from the returned data and connects the caller to it in a known manner.

Optionally the host server places a query via a centralised Number Portability Database (NPDB) (105) using Query on Release (QoR) as outlined in Internet Society paper RFC3482 to receive the current location of the called phone. The lookup of the location may involve queries to the donor network (ie the network which originally created the phone number) and from there a call to the network last recognised as having contact with the phone. Having received this information it is passed back to the originating server/exchange (102) with the actual phone number in a QoR. The originating server/exchange then completes the call to the identified telephone gateway server (107) and so to phone (108). Clearly the server (104) hosting the domain name must be using software which is capable of calling the NPDB database and of performing a QoR, however this will have been downloaded by the server as part of a the phone number handling package which provided the alias mechanism.

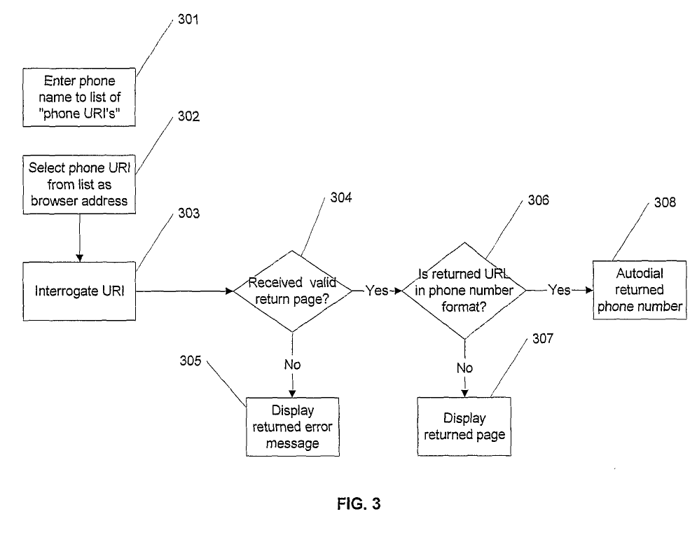

Drawing FIG. 3 shows an alternative method in which the phone, with a WAP display, may enter a phone name as one of several others in a list at (301). At (302) a phone name is selected from the list and the corresponding http address queried at (303). The querying phone receives a response at (304) which will be either an error message (305) (where the phone name does not exist) or a valid phone number encapsulated in a web page at (306) or another format recognised by the receiving phone as containing a phone number. Where a valid phone number is received the phone may autodial the number to connect to the called name as at (308) otherwise the returned page is displayed. It should be noted that the correspondence between the name and number is held and maintained centrally, as opposed to the usual cellphone where the name and number correspondence must be maintained locally by each user.

Where an address such as http://joel.bloggs$trisotto.com.au is used the process is required to be slightly different. Such a URI requires that the DNS contacted be set up to recognise this as an address to be referred to domain trisotto.com.au, ie that the portion of the address before the “$” be disregarded and treated as the DNS would normally treat a userinfo subcomponent. At the domain server the same process as above takes place, with the difference that the server need not recognize that the “page” is actually a request for a phone number. Instead the phone user name “joel.bloggs” is simply referred to a lookup table of phone numbers and the same request to an NPDB database and handoff by QoR is then performed.

The described methods place the main burden of determining the actual telephone number on the server for the domain name to which the telephone belongs, since this is where the domain name to phone number relationship is actually held. The phone number normally output from the domain name server is, where possible, a global telephone number, however the output may be the telephone number in local form, the NPDB database being relied upon to translate to a global number.

It is possible for an alternative system to operate in which each telephone does actually have a permanent IP address. Because of the transient nature of cellphones the address translation from name to IP address as held in the DNS servers is not likely to be validly located in a local server, and instead the request is routed to the relevant root domain name server (104). Here a lookup is performed to the IP address of the telephone and this is returned to server (102) and a search instigated for that address as present on a telephone gateway. Once found the audio signal packets may be transferred.

While the description relates to the use of the invention in simple hypertext transfer protocol the return of a phone number will work equally well as a web service, with the added advantage that the process is hidden as far as the user is concerned. Thus, in practice, a user will select or enter a phone name to call, the phone, connected to the internet, will call the web service to identify the actual phone number, and this will then be dialled automatically on receipt of the return from the web service.

The phone alias is preferably formed from an existing email or other address of the phone user so that it is easily remembered by the user. In most instances the transliteration of the users email address will provide a unique phone alias which is also valid as a web address.

It is to be understood that even though numerous characteristics and advantages of the various embodiments of the present invention have been set forth in the foregoing description, together with details of the structure and functioning of various embodiments of the invention, this disclosure is illustrative only, and changes may be made in detail so long as the functioning of the invention is not adversely affected. For example the particular elements of the telephone number lookup may vary dependent on the particular application for which it is used without variation in the spirit and scope of the present invention.

In addition, although the preferred embodiments described herein are directed to cellphones for use in a worldwide calling system, it will be appreciated by those skilled in the art that the teachings of the present invention can be applied to other systems such as local internal exchanges, without departing from the scope and spirit of the present invention.

### TECHNICAL APPLICABILITY

The application relates to a method and apparatus for allowing a telephone number to be expressed as a character string and to be accepted by the technical infrastructure throughout the world. As such it has technical applicability

1. A method of looking up a phone address as a URI comprising allocating a URI as the phone address, the URI being located within an existing authority domain, on interrogation of the domain recognising that the URI does not relate to a valid page, subsequently comparing the URI with a list of phone number aliases, and returning the phone number to which the alias relates to the interrogating process.

2. A method as claimed in claim 1 wherein the URI is a URL and the phone number alias is formatted as a userinfo subcomponent in an authority domain name.

3. A method as claimed in claim 2 wherein the URL includes a delimiter replacing the standard userinfo delimiter.

4. A method as claimed in claim 1 wherein the URI is a URL and the phone number alias is formatted as a subcomponent of the authority domain name with an identifiable first subcomponent.

5. A method as claimed in claim 4 wherein the first subcomponent is “gpn”.

6. A method of providing an alias to a telephone number comprising specifying a phone number alias as a validly formatted hypertext transfer protocol (HTTP) address, detecting on query at the server corresponding to the address that the address does not relate to a valid HTTP page, confirming that the address relates to a phone number alias, and returning to the querying process the phone number and location relating to the alias.

7. A method as claimed in claim 6 wherein the location identifies the phone code for a country.

8. A method as claimed in claim 6 wherein the phone number and location are returned in standard international phone number format.

9. An apparatus for translating a telephone number being syntactically a valid domain name, the apparatus having:
a recogniser at the server representing the domain name which detects the syntactically valid domain name as a non-existent domain name reference and attempts to match the syntactically valid domain name against an entry in a list of phone number aliases
wherein on detecting a match the recogniser returns the phone number of which the syntactically valid domain name is the alias.

10. An apparatus for translating a telephone number alias presented as a userinfo prefix, an authority domain name suffix and a valid URI separator between the two, the apparatus having:
a domain name recogniser
a recogniser for the separator which recognises it as denoting the prefix as being a phone number alias
a phone number alias lookup which returns the phone number equivalent to the userinfo prefix.

11. An apparatus as claimed in claim 10 wherein the apparatus is incorporated in a web server.
